(19) United States
(12) Patent Application Publication
(10) Pub. No.: US 2015/0237876 A1
(43) Pub. Date: Aug. 27, 2015

(54) DISPOSABLE FOOD SMOKING APPARATUS, A FOOD SMOKING CAKE, AND A METHOD OF FORMING A FOOD SMOKING CAKE

(71) Applicant: Martin Christopher Abram, Troon (GB)

(72) Inventor: Martin Christopher Abram, Troon (GB)

(21) Appl. No.: 14/629,815

(22) Filed: Feb. 24, 2015

(30) Foreign Application Priority Data
Feb. 27, 2014 (GB) 1403434.2

(51) Int. Cl. A23B 4/052; C10L 5/36

(52) U.S. Cl. CPC A23B 4/0523; C10L 5/368

(57) ABSTRACT

A food smoking cake 418, 52, 54 comprises a discrete block configured to be placed into abutment with at least one substantially similar block such that when an end one of a series of abutting blocks is lit by a flame, adjacent abutting blocks will each smoulder sequentially.

### CROSS-REFERENCE TO RELATED PATENT APPLICATIONS

This application claims the priority benefit to GB Patent Application No. GB1403434.2, titled “Food Smoking Cake and Disposable Food Smoking Apparatus”, filed 27 Feb. 2014, the entire contents of which are incorporated into this document. In the event of a conflict, the subject matter explicitly recited or shown in this document controls over any subject matter incorporated by reference. The incorporated subject matter should not be used to limit or narrow the scope of the explicitly recited or depicted subject matter.

### FIELD

The present invention relates to a food smoking cake, particularly, but not exclusively, a food smoking cake used to cold-smoke food in a closed food smoking container such as a barbeque or food smoking chamber. The present invention also relates to a disposable food smoking apparatus which includes a food smoking cake. The present invention also relates to a method of forming a food smoking cake.

### BACKGROUND

The practice of smoking foodstuffs in order to preserve them and impart a smoked flavour thereto has been popular for centuries. This can either be achieved by way of hot-smoking (where smoke is passed over the foodstuffs whilst they are heated and cooked) or by cold-smoking (where cool smoke is passed over the foodstuffs in order to smoke them without cooking as such). Cold-smoking requires a significant quantity of cool smoke to be created over a prolonged period of time (normally several hours) in order to achieve best results.

Creating such quantities of cool smoke over prolonged periods can often be difficult to achieve. This is because, over long periods, such combustible materials typically either have a tendency to catch fire or extinguish themselves prematurely.

Furthermore, even if such combustible materials do not extinguish or catch fire, variations in the combustion temperature can lead to dramatic variations in the smoke levels produced during smoking which can have adverse effects on the consistency of the resulting smoked food product.

It is known to use specifically engineered “smoke pellets” to reliably provide large quantities of smoke over prolonged periods of time; however, such pellets tend to include chemical compounds or formulations which, at best, will adversely affect the taste of the food and any resulting enjoyment in consuming those foods or, at worst, are completely unsuitable for the smoking of food for human consumption in view of the taste imparted on the foodstuffs and/or chemicals to which the foodstuffs would be thereby exposed. In addition, such products are often unable to generate smoke over a sufficiently long duration due to dimension and other limitations. Furthermore, the chemical composition of such products typically requires them to be lit by a relatively heavy duty flame from e.g. a butane torch.

One solution to the above problem is described in UK Patent Publication No. GB52471296. This arrangement has a metal container which forms a convoluted channel that receives loose particles of wood dust therein. With such an arrangement, in order to begin the smouldering/smoke generation process, a candle is lit beneath one end of the convoluted channel in order to light that end of the trail of wood dust. Eventually after a few minutes, the wood dust should then begin to smoulder thereby creating cool smoke; however, this arrangement has a number of disadvantages such as:—
Filling the container with loose particles of wood dust and levelling it off is messy and can give inconsistent results;
The candle must be held under the wood dust for a long period of time (a few minutes before the wood dust begins to smoulder);
The candle must be removed once the wood dust begins to smoulder which is awkward and dangerous since the candle is hot by this point;
There is a tendency for the wood dust to either not light or to extinguish prematurely;
The apparatus is difficult to clean. This can result in poor performance after only a single use since burnt debris and fat etc. can clog the mesh thereby adversely affecting air flow during smouldering.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY

It is an object of the present invention to provide a food smoking cake that goes at least some way towards overcoming the above disadvantages, or which at least provides the public with a useful choice. It is a further object of the invention to provide a disposable food smoking apparatus that that goes at least some way towards overcoming the above disadvantages, or which at least provides the public with a useful choice.

The term “comprising” as used in this specification and indicative independent claims means “consisting at least in part of” and is intended as an inclusive rather than exclusive term. When interpreting each statement in this specification and indicative independent claims that includes the term “comprising”, features other than that or those prefaced by the term may also be present. Related terms such as “comprise” and “comprises” are to be interpreted in the same manner

As used herein, the term “and/or” means “and” or “or”, or both.

As used herein “(s)” following a noun means the plural and/or singular forms of the noun.

Accordingly, in a first aspect the present invention may broadly be said to consist in a food smoking cake comprising: a discrete block configured to be placed into abutment with at least one substantially similar block such that when an end one of a series of abutting blocks is lit by a flame, adjacent abutting blocks will each smoulder sequentially.

In an embodiment, the discrete block comprises a main body having a projecting ledge section at one end and a corresponding shoulder section at the opposed end configured such that the ledge of one discrete block can be rested upon a corresponding shoulder section of an adjacent block.

In an embodiment, the discrete block comprises a main body having a male portion at one end and a female portion at the opposed end, the female portion substantially corresponding to the male portion, the male and female portions configured such that a plurality of the discrete blocks can be arranged end-to-end in series with the male portion of one block in contact with the female portion of the adjacent block, and wherein contact between the male and female portions facilitates passage of smoulder heat from one block to the next.

In an embodiment, the discrete block further comprises a curved or otherwise profiled underside configured to facilitate circulation of air underneath the blocks during smouldering thereof.

In an embodiment, the discrete block further comprises a loose particulate receiving chamber configured to receive a complementary loose particulate therein.

In an embodiment, the complementary loose particulate receiving chamber comprises a groove or channel provided along at least a portion of an upper surface of the discrete block.

In an embodiment, the complementary loose particulate receiving chamber comprises a throughbore provided along at least a portion of the discrete block.

In an embodiment, the material that forms the discrete block comprises: a minor part combustible natural plant base particulate which smoulders when lit by a flame, and; a major part combustible wood base particulate which produces smoke when smouldering.

In an embodiment, the combustible natural plant base particulate comprises a powder or resin derived from tree bark.

In an embodiment, the combustible natural plant base particulate comprises makko powder from the persea genus.

In an embodiment, the combustible natural plant base particulate comprises makko powder from the machilus thunbergii tree.

In an embodiment, the combustible natural plant base particulate comprises xiangnan pi from the phoebe genus.

In an embodiment, the natural plant base particulate comprises substantially between 1 to 20% of the material and the combustible wood base comprises substantially between 80 to 99% of the mixture.

In an embodiment, the natural plant base particulate comprises substantially 10% and the combustible wood base comprises substantially 90% of the material.

In an embodiment, the combustible wood base particulate comprises powdered wood particulates obtained from at least one of the group consisting of oak, beech, hickory, maple, cherry, apple, pear, or alder wood.

In an embodiment, the combustible wood base particulate further comprises at least one of herbaceous matter, infusions, flavour enhancers or other aromatic tinctures.

In a second aspect the invention may broadly be said to consist in a disposable food smoking apparatus configured to create smoke over a prolonged period of time in order to impart a smoked flavour on food, the food smoking apparatus comprising: a base configured to rest on a surface, and; a food smoking cake.

In an embodiment, the body of the food smoking cake comprises a convoluted form configured such that if one end of the convoluted form is lit by flame the cake will smoulder progressively along the length of the body.

In an embodiment, the convoluted form comprises an upwardly extending coiled helix configuration.

In an embodiment, the base further comprises an upwardly projecting mounting member configured so that an upwardly extending helical coil of food smoking cake can be positioned there around,

In an embodiment, the disposable food smoking apparatus further comprises a cover configured to enclose the mounting member and cake, the cover having at least one lower air breathing aperture, and at least one upper smoke exhaust aperture.

In an embodiment, the cover further comprises an air regulator located at or close to the lower air breathing aperture configured to control air flow through the lower air breathing aperture to control the rate of combustion and hence smoke levels produced by the food smoking cake when lit.

In an embodiment, the base is configured to form a container adapted to receive the food smoking cake therein, the container and cake mutually configured so that the cake can locate within the container as a unitary item.

In an embodiment, the convoluted form comprises a flattened, convoluted configuration.

In an embodiment, the disposable food smoking apparatus further comprises a lower aerating shelf locating in use within the base portion and configured to retain the food smoking cake and space the cake away from the floor of the container.

In an embodiment, the lower aerating shelf comprises a wire mesh grill.

In an embodiment, the disposable food smoking apparatus further comprises an upper retaining shelf configured to locate on top of the food smoking cake to sandwich the food smoking cake between the upper retaining shelf and the lower aerating shelf.

In an embodiment, the upper retaining shelf comprises a wire mesh grill.

In an embodiment, the base further comprises a first access aperture configured to allow external access to a first end of the food smoking cake so that the cake can be lit by a flame.

In an embodiment, the base further comprises a second access aperture configured to allow external access to a second end of the food smoking cake so that the cake can be lit by a flame.

In an embodiment, the base further comprises at least one hinged flap of material configured to be movable between a position where the access aperture is open, and a position substantially closing the access aperture.

In an embodiment, the base plate further comprises at least one slider configured to be movable between a position where the access aperture is open, and a position substantially closing the access aperture.

In an embodiment, the disposable food smoking apparatus further comprises a drip tray having at least one aperture therethrough and configured to locate in use atop the upper retaining shelf.

In a third aspect, the invention may broadly be said to consist in a method of forming a food smoking cake comprising the steps of: choosing a combustible wood base particulate of the type that produces smoke when smouldering; choosing a combustible natural plant base particulate of the type that smoulders when lit by a flame; combining the wood base particulate and natural plant base particulate with a binding agent to form a substantially homogenous and malleable mixture with the wood base particulate as the major portion thereof; forming the mixture into the required shape or shapes, and; drying the formed mixture to remove the binding agent therefrom.

In an embodiment, in the step of combining the wood base particulate and natural plant base particulate with a binding agent, the binding agent is a liquid.

In an embodiment, in the step of combining the wood base particulate and natural plant base particulate with a binding agent, the binding agent is water.

In an embodiment, in the step of forming the mixture into the required shape or shapes the forming operation can be performed by one or more of hand forming, press moulding or by extrusion from a tube.

In an embodiment, in the step of choosing a combustible natural plant base particulate, the plant base particulate chosen comprises a powder or resin derived from tree bark.

In an embodiment, the plant base particulate chosen comprises makko powder from the persea genus.

In an embodiment, the plant base particulate chosen comprises makko powder from the machilus thunbergii tree.

In an embodiment, the plant base particulate chosen comprises xiangnan pi from the phoebe genus.

In an embodiment, in the step of combining the wood base particulate and natural plant base particulate the mixture is formed so that natural plant base particulate comprises substantially between 1 to 20% of the material in the mixture.

In an embodiment, in the step of combining the wood base particulate and natural plant base particulate the mixture is formed so that natural plant base particulate comprises substantially 10% of the material in the mixture.

In an embodiment, in the step of choosing the combustible wood base particulate, the wood base particulate chosen comprises powdered wood particulates obtained from at least one of the group consisting of oak, beech, hickory, maple, cherry, apple, pear, or alder wood.

In an embodiment, the combustible wood base particulate further comprises at least one of herbaceous matter, infusions, flavour enhancers or other aromatic tinctures.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 shows a perspective view of disposable food smoking apparatus according to an embodiment of the present invention;

FIG. 2 shows a plan view of the food smoking apparatus of FIG. 1;

FIG. 3 shows an end perspective view of the food smoking apparatus of FIGS. 1 and 2 where an access aperture is shown opened at one end thereof;

FIG. 4 shows a more detailed view of the opened access aperture shown in FIG. 3;

FIG. 5 shows a perspective view of the disposable food smoking apparatus of FIGS. 1 to 4 with a removable drip tray provided;

FIG. 6 shows a plan view of disposable food smoking apparatus with a food smoking cake having an alternate form to that of FIGS. 1 to 5 provided and where a pair of access apertures are provided in the tray of the apparatus to allow both ends of the food smoking cake to be lit by a flame;

FIG. 7a shows a perspective view of the disposable food smoking apparatus and food smoking cake of FIG. 6;

FIG. 7b shows a sectional view of the food smoking apparatus and food smoking cake of FIG. 7a, cut across the centre line of the apparatus and cake from front to rear, the left hand side or half shown only.

FIG. 8 shows a view of an alternative embodiment of the invention where an alternative form of food smoking cake is provided coiled around an upright member; in this illustration a cover of the apparatus is removed;

FIG. 9 shows a view of the arrangement shown in FIG. 8 where the cover of the apparatus is in place over the coiled food smoking cake;

FIG. 10 shows a side view of an embodiment of the food smoking cake of the present invention in the form of first and second interlocked discrete blocks in abutment with each other;

FIG. 11 shows a view of the interlocking discrete blocks of FIG. 10 out of abutment with each other;

FIG. 12 shows a side view of an alternative embodiment of food smoking cake as a discrete block having a curved under section and a projecting ledge section;

FIG. 13 shows a view of a series of the discrete blocks shown in FIG. 12 resting on one another to provide a chain of blocks;

FIG. 14 shows a view of the blocks of FIG. 12 shown arranged in a dog-leg arrangement;

FIG. 15 shows a view of the blocks of FIG. 12 shown arranged in a curved formation;

FIG. 16 shows an alternative form of food smoking cake formed as a discrete block where a greater degree of curvature is provided in both the bottom and top surfaces of the block;

FIG. 17 shows a perspective view of food smoking cake formed as a discrete block where no male protruding member is provided and where a loose particulate channel is provided along the upper surface of the discrete block;

FIG. 18 shows a perspective view of food smoking cake formed as a discrete block where a male protruding member is provided and where a loose particulate channel is provided along the upper surface of the discrete block;

FIG. 19 shows a pair of the discrete blocks of FIG. 18 shown in abutment against one another and where loose particulate resides within the upper channel of one discrete block;

FIG. 20 shows a perspective view of food smoking cake formed as a discrete block where a central throughbore is provided for receipt of loose particulate therein; and

FIG. 21 shows a perspective view of the discrete block shown in FIG. 20 where loose particulate resides within the central throughbore.

### DETAILED DESCRIPTION OF EXEMPLARY EMBODIMENTS

In the present application the term wood “particulate” means any type of wood chippings or powder where the grains of the particulate have a relatively small dimension and includes for example, saw dust, wood powder, wood chippings etc.

In the present application the term “cake” should be taken to mean a unitary shaped, moulded or compressed mass.

In order to form an embodiment of food smoking cake of the present invention, approximately 10% combustible natural plant base particulate (such as makko powder) and approximately 90% combustible wood base particulate (such as wood dust from e.g. a beech tree) are mixed with a small quantity of binding liquid such as water in order to bind the combined mixture into a soft, malleable patty. This patty is then shaped into the required shape of food smoking cake and subsequently dried to remove the water therefrom. Drying of the resulting food smoking cake can be achieved by warming or dehydrating of the cake in order to encourage the water previously introduced into the mixture as a binder to evaporate thereby forming a dried food smoking cake.

Shaping of the patty into the required formation can be performed by hand, by press moulding or by extrusion from a tube etc.

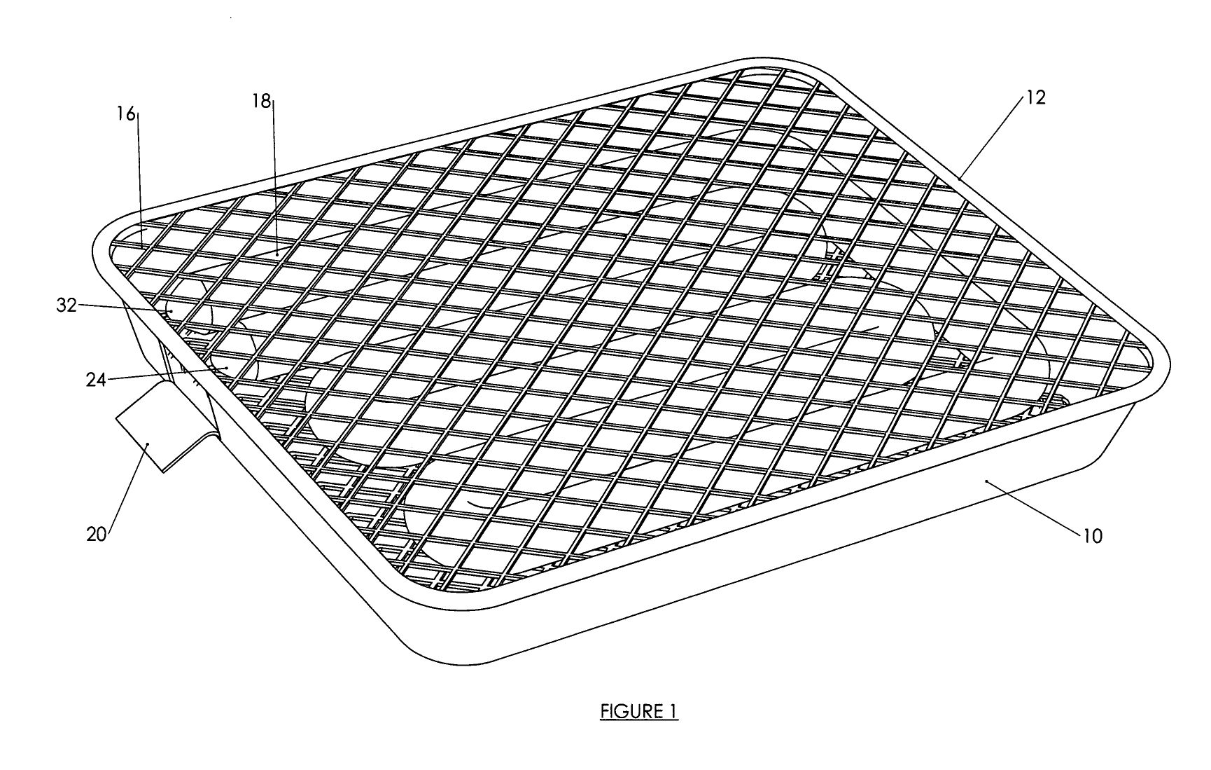

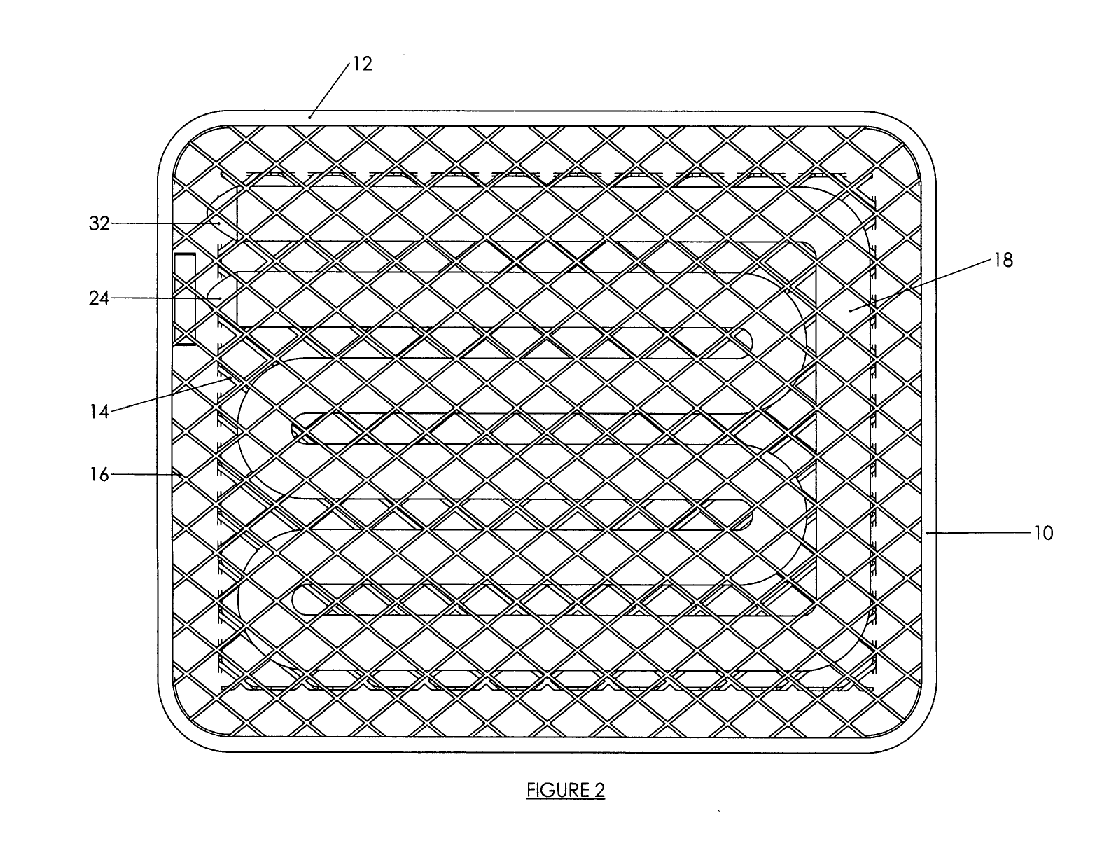

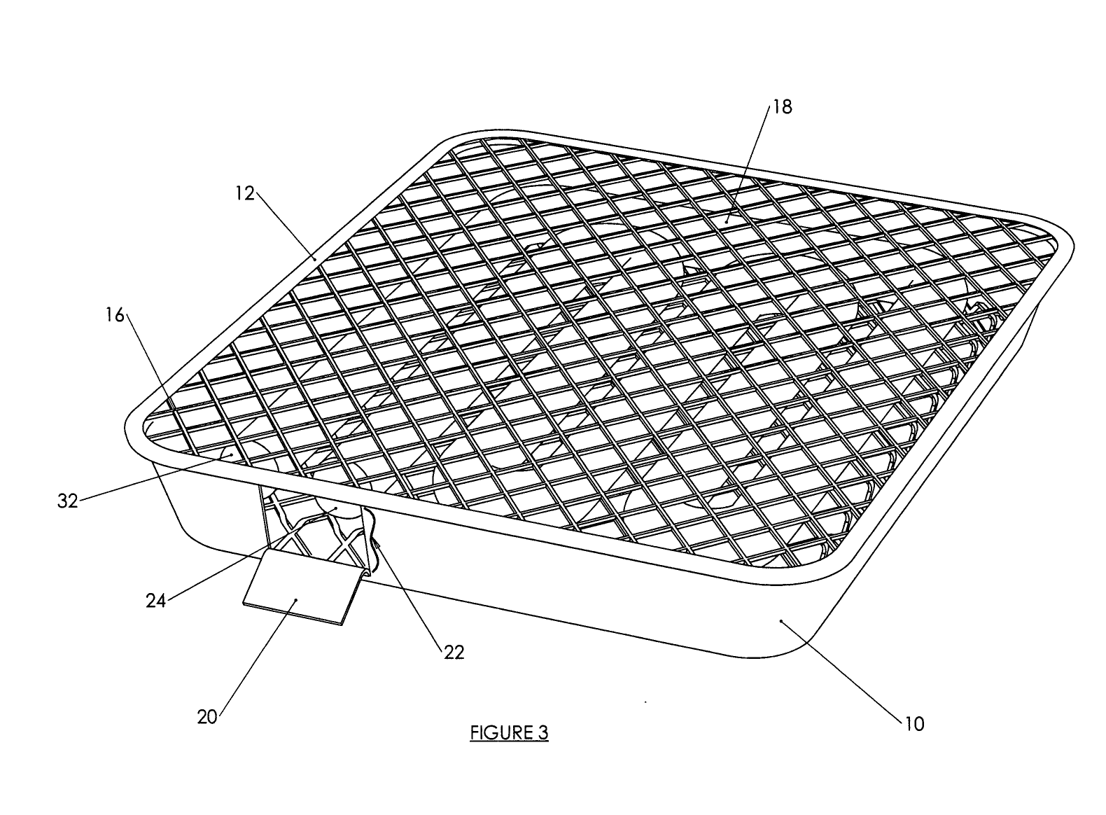

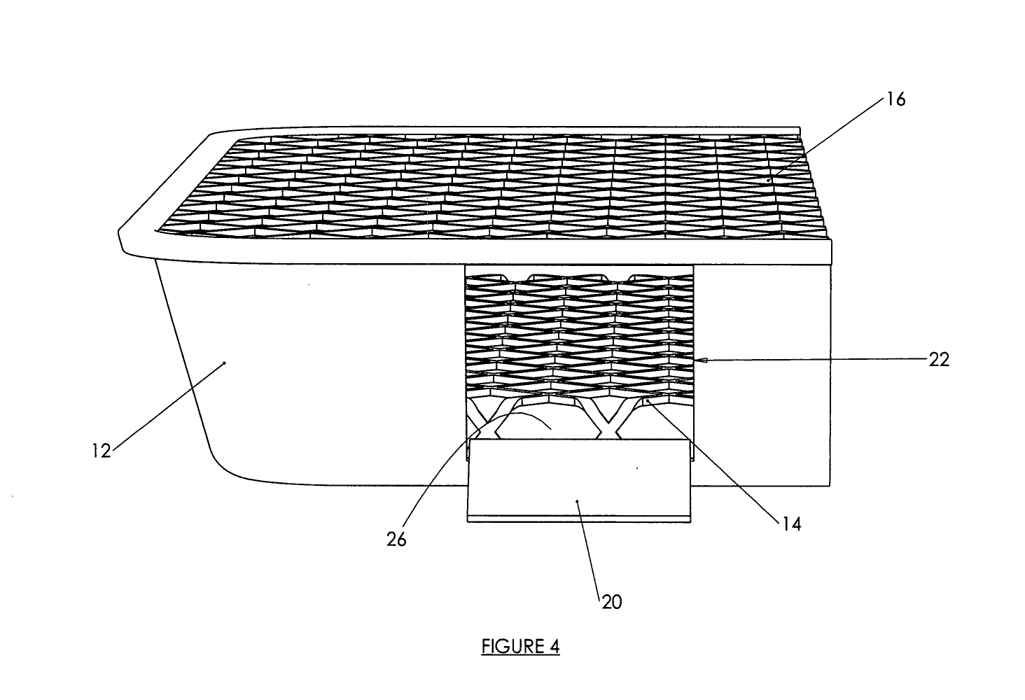

In a first embodiment, the patty is formed into a convoluted concertina shape as shown in FIGS. 1 to 5. In this embodiment, the patty is located inside a food smoking apparatus 10 that comprises a disposable foil tray 12 within which is mounted a lower disposable mesh aerating shelf 14 and an upper disposable mesh retaining shelf 16. The convoluted food smoking cake 18 (formed from the mixture of combustible natural plant base particulate and combustible wood base particulate as previously described) is sandwiched between the lower aerating shelf 14 and the upper retaining shelf 16 in order to secure the food smoking cake 18 in a raised configuration towards the upper mouth of the disposable foil tray 12.

The disposable foil tray 12 is provided with a hinged flap 20 in one side wall thereof in order to provide a combined access and air breathing aperture 22. The combined access and air breathing aperture 22 allows air to be drawn into the disposable tray 12 during smouldering and also allows a user to access a first end 24 of the convoluted food smoking cake 18 for lighting thereof.

The edges of the lower aerating shelf 14 are bent over in order to support itself on a base 26 of the tray 12 such that the shelf 14 is spaced away from the base 26 by a sufficient amount to allow air to freely flow under the convoluted food smoking cake 18.

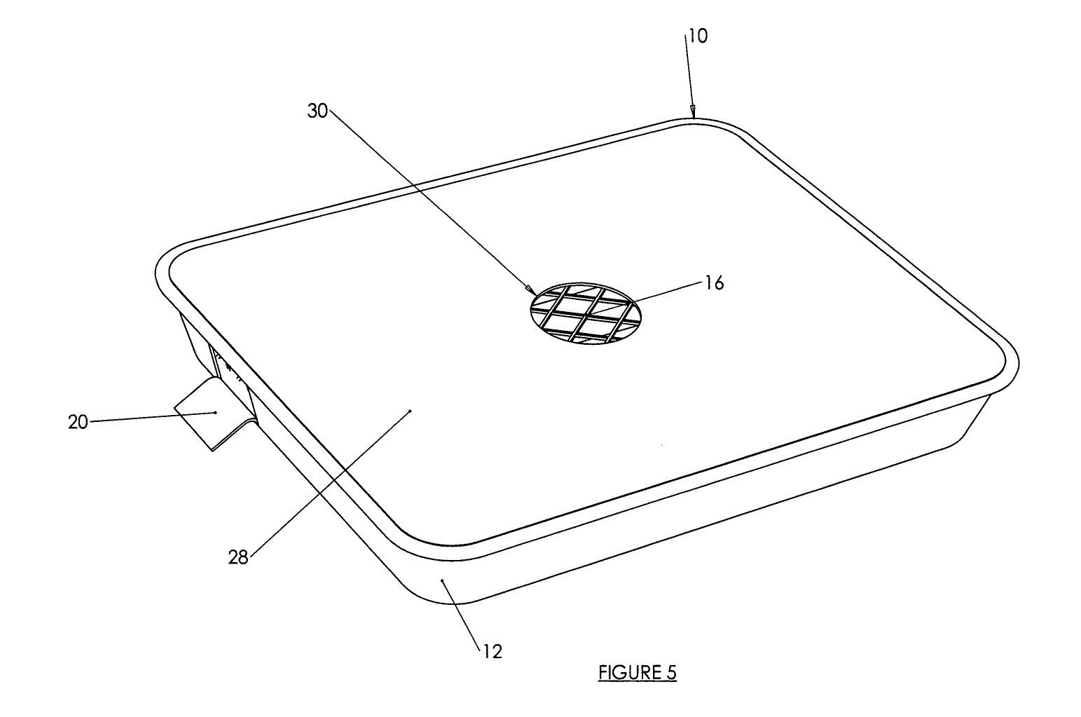

As shown in FIG. 5 a drip tray 28 is optionally provided atop the upper disposable mesh 16 in order to prevent drips from any food placed there above entering the tray 10 during use. In the embodiment shown, the drip tray 28 is provided with a central exhaust aperture 30 which allows smoke to escape from the tray 10 during use; however, it will be appreciated that several smaller apertures could be provided through the drip tray 28 in order to provide a similar function.

Due to the stable, dry nature of the food smoking cake described, the apparatus 10 can be stored for long periods of time before use without any adverse effect on its eventual smouldering/smoking properties. Furthermore, the protection offered by the disposable foil tray 12 and the upper and lower meshes 14, 16 prevents the food smoking cake 18 from being damaged in transport.

In use, when a user wishes to create smoke for the cold smoking of foods they first open the flap 20 in order to gain access to aperture 22 and then light the first end 24 of the convoluted food smoking cake 18 with a suitable flame (e.g. a gas lighter, candle or match etc.). Due to the readily combustible nature of the food smoking cake 18, within a very short time (a few seconds) of being exposed to the flame the first end 24 of the food smoking cake 18 will begin to smoulder thereby creating smoke; however, it will not catch fire due to the inherent combustible properties of the combined makko powder and wood base mixture which are optimised for smouldering but not for burning. As used in this specification, the term ‘smouldering’ should be taken to mean ‘combusting without a visible flame’, and the term ‘burning’ to mean ‘combusting with a visible flame’.

With the food smoking cake 18 lit, the user can place the drip tray 28 on top of the disposable tray 12 and then place the disposable food smoking apparatus 10 in a suitable enclosed space (such as a barbeque or food smoking chamber) for cold smoking of food. Alternatively, the drip tray 28 can be provided sealed onto the top of the tray 12 as a non-removable drip tray if desired.

Once smouldering of the food smoking cake 18 has begun the smoulder line (the point at which smoulder is sustained and hence smoke is created along the length of the food smoking cake 18) will progress along the convoluted path defined by the food smoking cake 18 until it reaches the second end 32 of the food smoking cake 18, at which point, with all fuel having been combusted, the smoulder will extinguish. In the present embodiment the dimensions of the food smoking cake 18 are selected to provide a sufficient quantity of smoke for the cold-smoking of food for around 8 to 12 hours depending upon conditions (such as draughts or the hinged flap 20/draught aperture control position etc.). In this regard, in the present embodiment, the smoulder rate is selected to typically be around 3-9 cm per hour. However, the reader will appreciate that this can be readily altered by selecting different dimensions of the food smoking cake 18 during manufacture and/or different positions for the hinged flap 20/draught aperture control position.

Throughout the above described process, improved smouldering of the food smoking cake 18 is facilitated by the air gap provided below the food smoking cake 18 as provided by the aerating mesh 14 being spaced apart from the base 26 of the disposable tray 10. Furthermore, since the aerating mesh 14 is raised from the base 26 of the tray 10, any depleted ash deposited as the food smoking cake 18 smoulders will fall through the aerating mesh 14 and onto the base 26. This further facilitates the smouldering process by preventing the depleted ash from “dampening” or “snuffing out” the smoulder. In addition, this also results in a cleaner smoulder which avoids acridity being imparted on the food being smoked.

Once smoking of the food has been completed, the food smoking apparatus 10 (and associated ash) may simply be discarded. If smoking of the food is adjudged to be complete by the user prior to the entire length of the food smoking cake 18 being used, the user may extinguish the smoulder with a small amount of water or by starving the smoulder of oxygen by way of a lid etc. If a sufficient quantity of the food smoking cake 18 is left, the remainder can be used in future food smoking sessions.

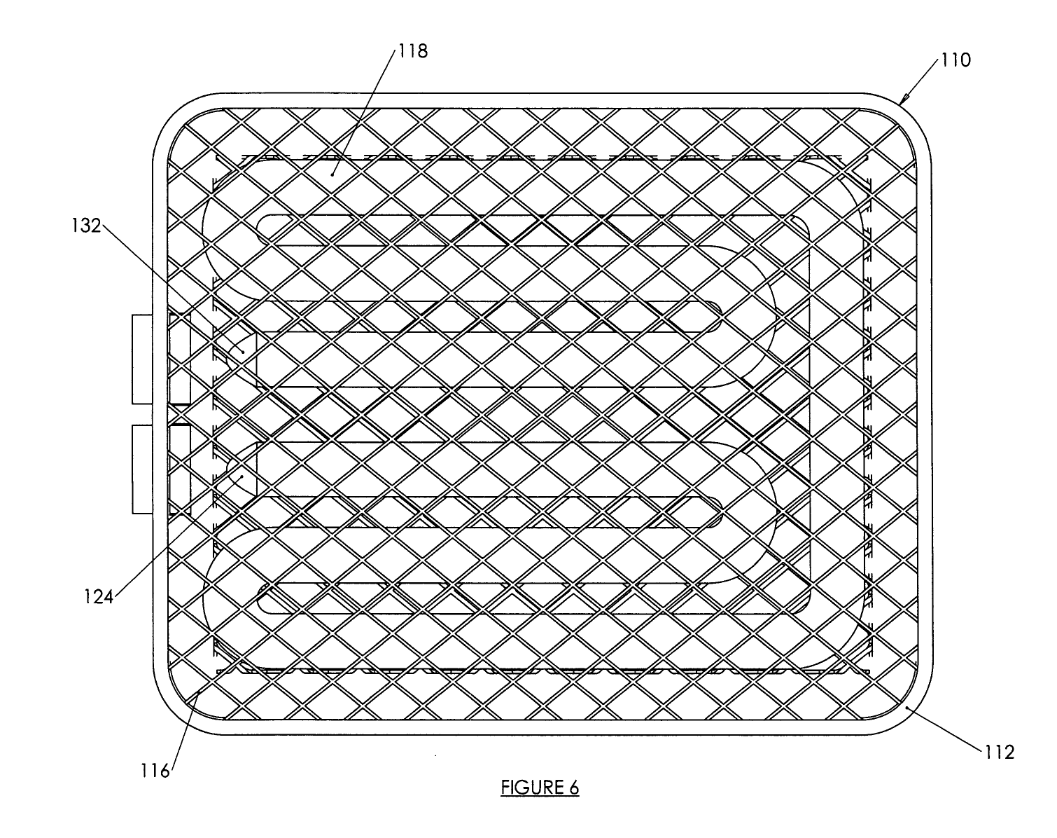

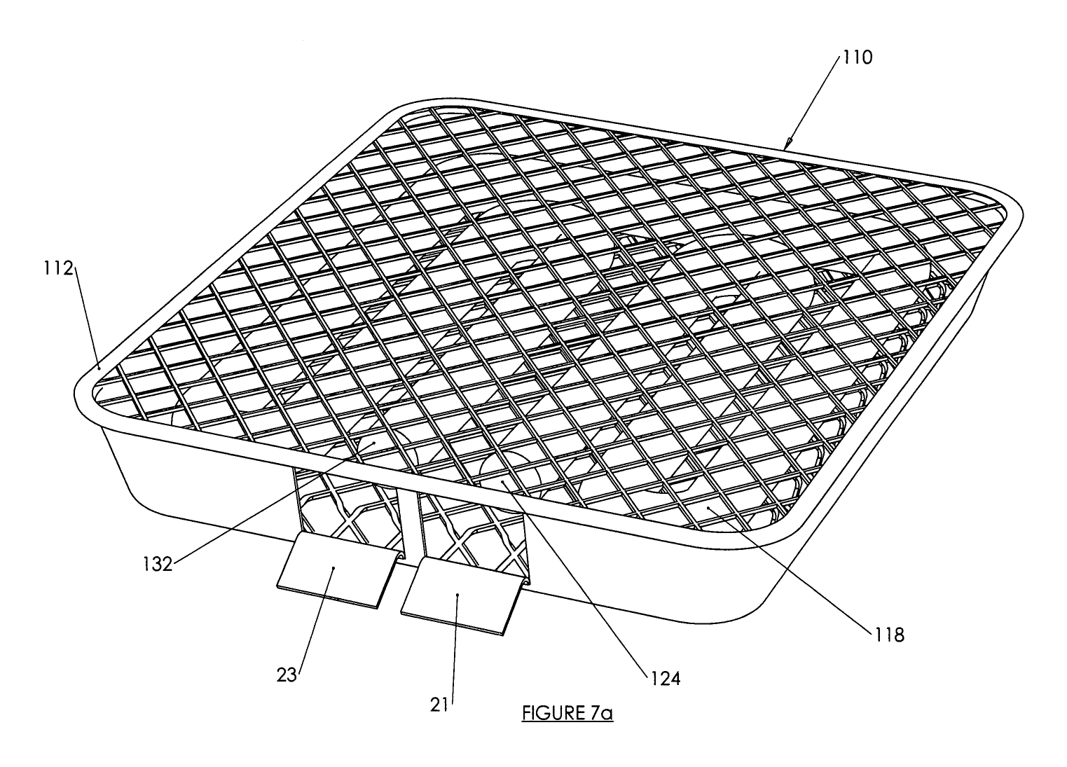

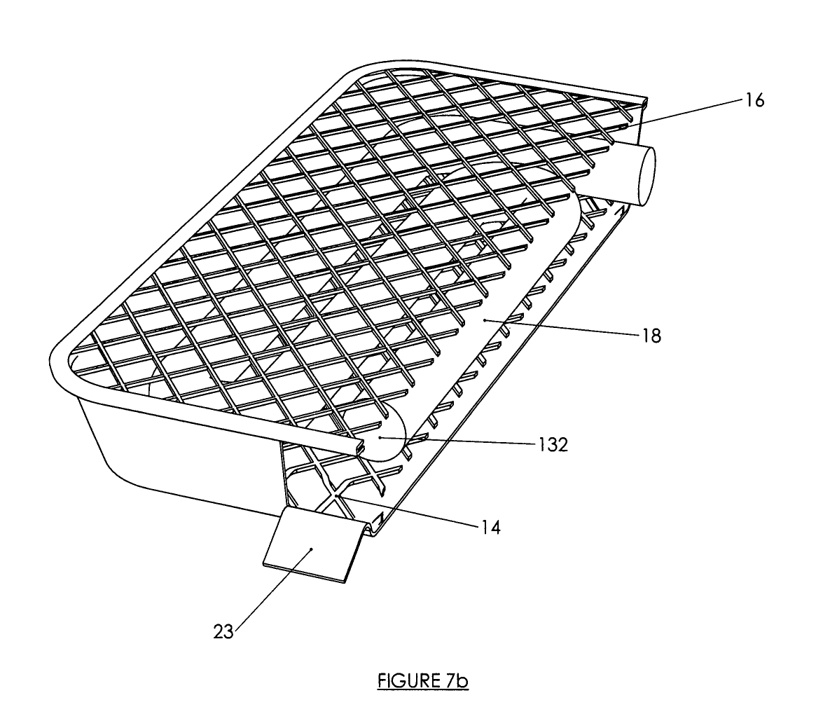

With reference to FIGS. 6 and 7 a second embodiment of the present invention will now be described. In order to minimise repetition, similar features of the apparatus described subsequently are numbered with a common two-digit reference numeral and are differentiated by a third digit placed before the two common digits. Such features are structured similarly, operate similarly, and/or have similar functions as previously described unless otherwise indicated.

In the second embodiment, the disposable food smoking apparatus 110 comprises a convoluted food smoking cake 118 which is coiled such that its first end 124 and its second end 132 are located adjacent one another towards the centre of the food smoking apparatus 110. A first hinged access flap 21 is provided adjacent the first end 124 of the cake 118 and a second hinged access flap 23 is provided adjacent the second end 132 of the cake 118 such that the cake can be lit by flame from either or both ends thereof. This allows the user to select a longer smoulder time with a reduced quantity of smoke being produced at any given time (by lighting only one end of the food smoking cake 118) or a shortened smoulder time with an increased quantity of smoke being produced at any given time (by simultaneously lighting both ends of the cake 118).

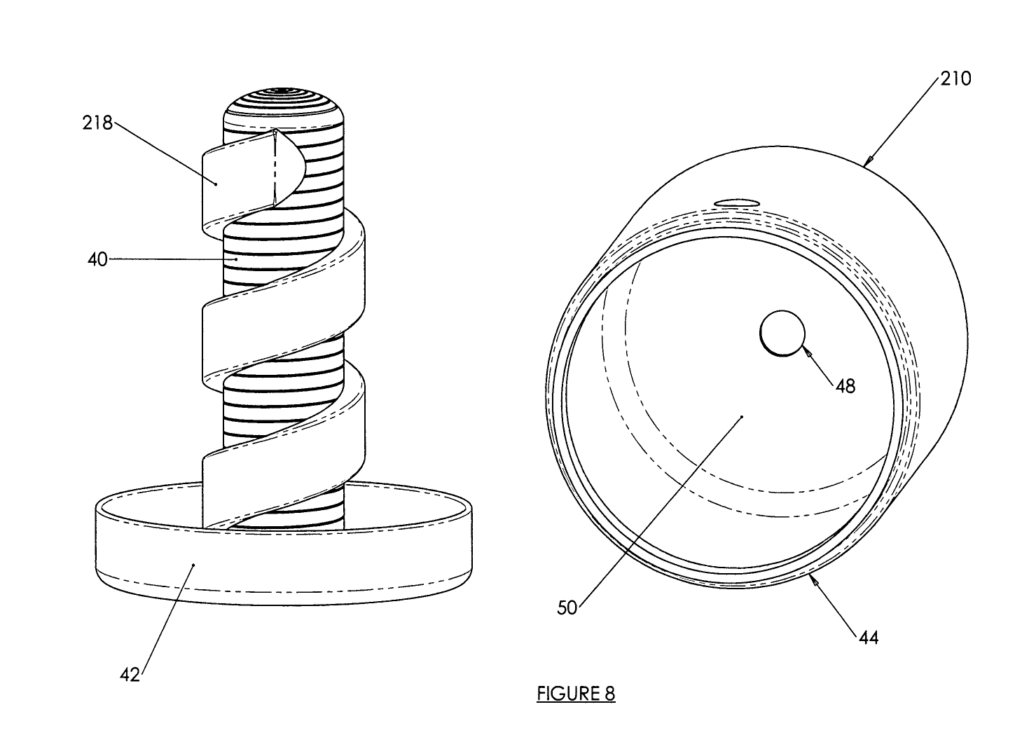

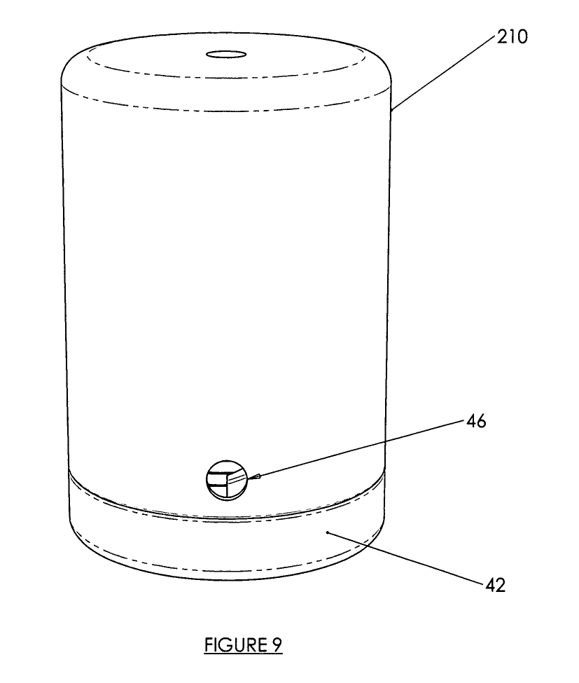

In a third embodiment of the present invention, as shown in FIGS. 8 and 9, the disposable food smoking apparatus 210 comprises a central tower 40, which projects upwardly from a base plate 42, and a cylindrical cover 44 which may be placed over the central tower 40. A food smoking cake 218 (formed from the mixture of combustible natural plant base 20 particulate and combustible wood base particulate as previously described) is coiled around the central tower 40 in a helix formation.

The cover 44 comprises an air draw hole 46 (FIG. 9) through its lower side wall and a smoke exhaust hole 48 (FIG. 8) in its upper closure plate 50. Additional smoke exhaust holes or air draw holes may be provided as desired in order to adjust and control the quantity of smoke produced at any given time. Indeed, the smoke exhaust hole 48 and/or the air draw hole 46 may be provided with a movable closure to allow a user to control the quantity of smoke produced at any given time.

In use, when the user wishes to light the food smoking apparatus 210 of the second embodiment, the top of the coiled food-smoking cake 218 is lit and the cover 44 is then placed on top of the base plate 42 as shown in FIG. 9. As the food smoking cake 218 smoulders, the smoulder line will therefore work its way down and around the coiled shaped thereof. In this way, any ash created will fall to the bottom of the apparatus 210 and be collected by the base plate 42.

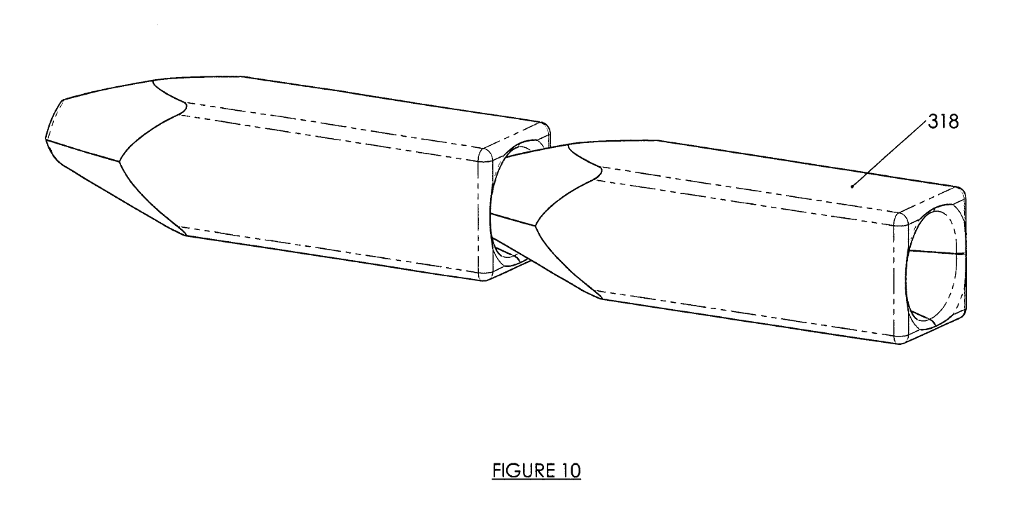

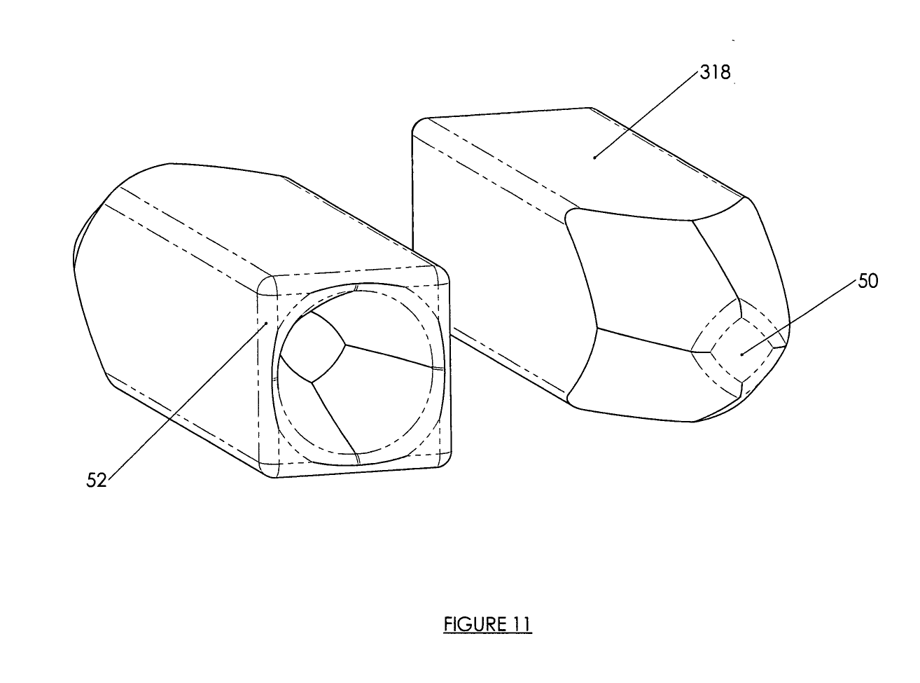

With reference to FIGS. 10 and 11 a second aspect of the invention will now be described in which the material of the food smoking cake previously described is shaped into particular discrete block formations. Each of the block formations 318 has a male portion 50 projecting from one end thereof and a corresponding female portion in the other end thereof such that when one such discrete block 318 is placed into end-to-end abutment with another such discrete block 318, the blocks are retained in physical contact with one another as shown in FIG. 10.

In use, several discrete blocks 318 can be arranged in alignment with one another.

This abutment between each block is sufficient to transfer the heat of one discrete smouldering block 318 to the next discrete smouldering block 318 when the smoulder line reaches the male/female intersection between each block 318.

This allows a user to select the desired number of discrete blocks 318 in order to provide cold-smoking for a specific amount of time. For example, if each block is sized and dimensioned during manufacture to smoulder for approximately 20 minutes, and the user wishes to smoke food for six hours then the user can align twelve blocks end to end (or in a spiral/dog leg formation) to provide this.

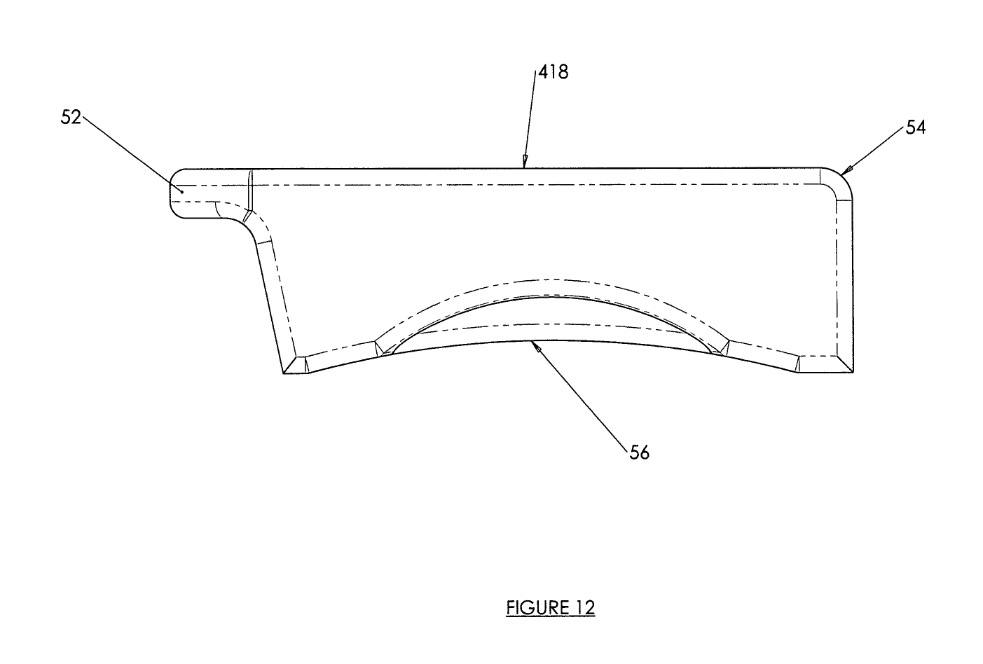

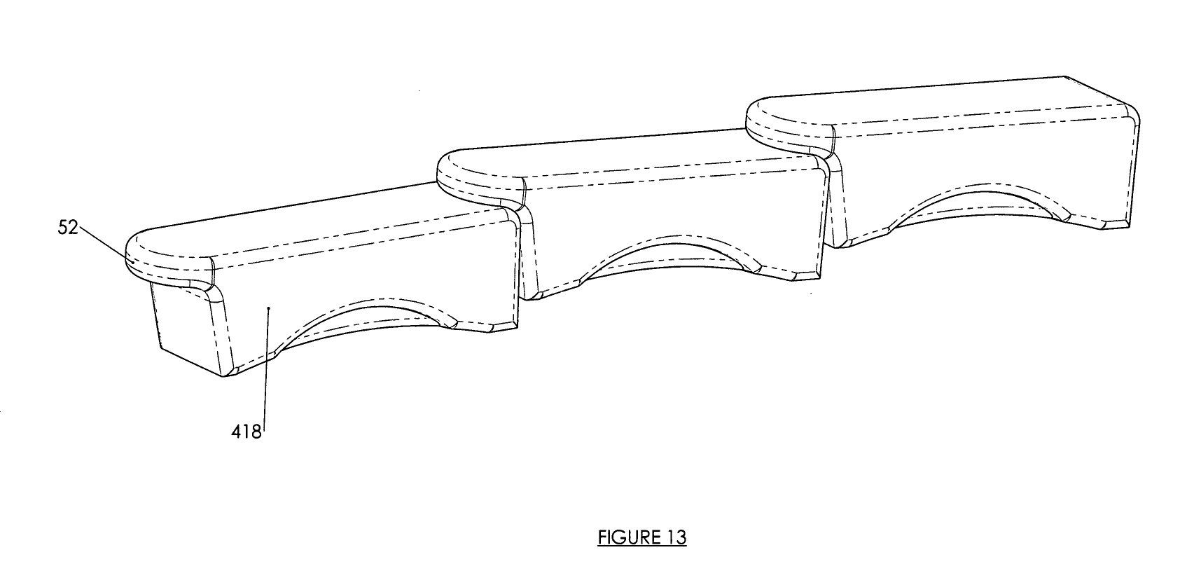

With reference to FIGS. 12 and 13, a further embodiment according to the second aspect of the invention comprises a discrete block formation 418 having a male portion in the form of a ledge 52 projecting from one end thereof. The end of each discrete block 418 opposite the ledge 52 comprises a corresponding shoulder 54.

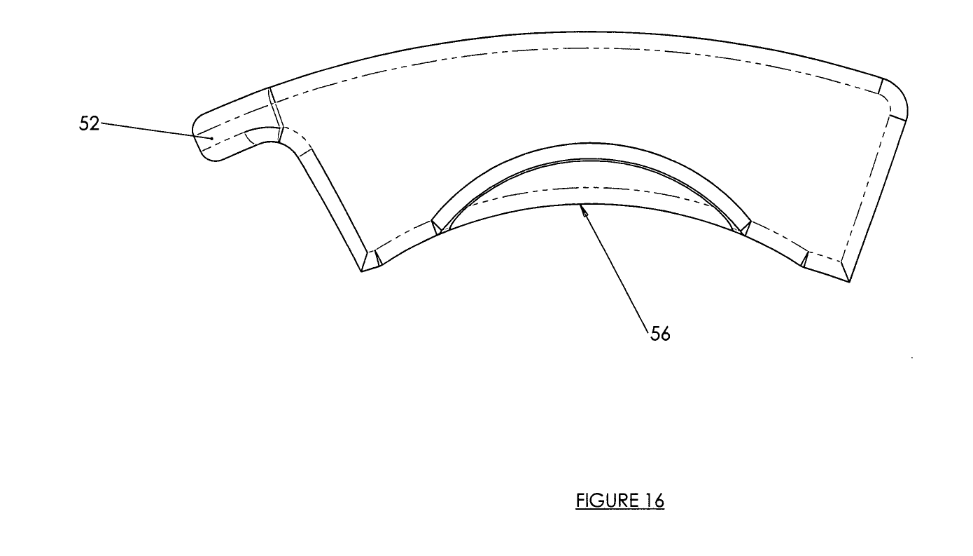

The lower surface 56 of each discrete block 418 is arched in order to provide an air-gap there below in order to facilitate improved smouldering of the block 418 in use. As shown in FIG. 16, the curvature of the arch in the lower surface 56 may be increased in order to provide a larger air gap thereunder if desired.

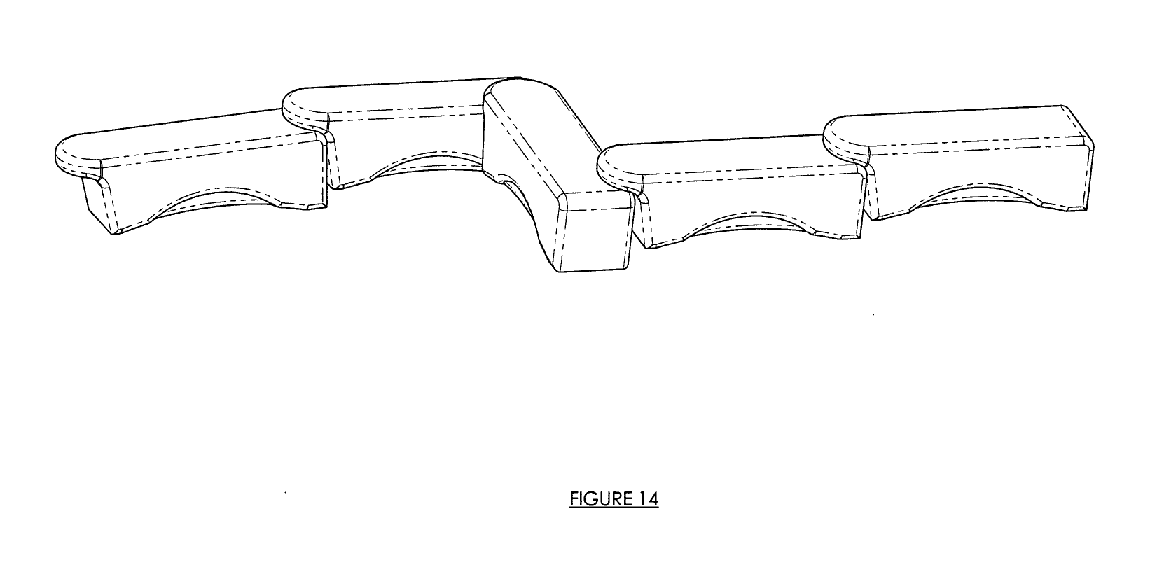

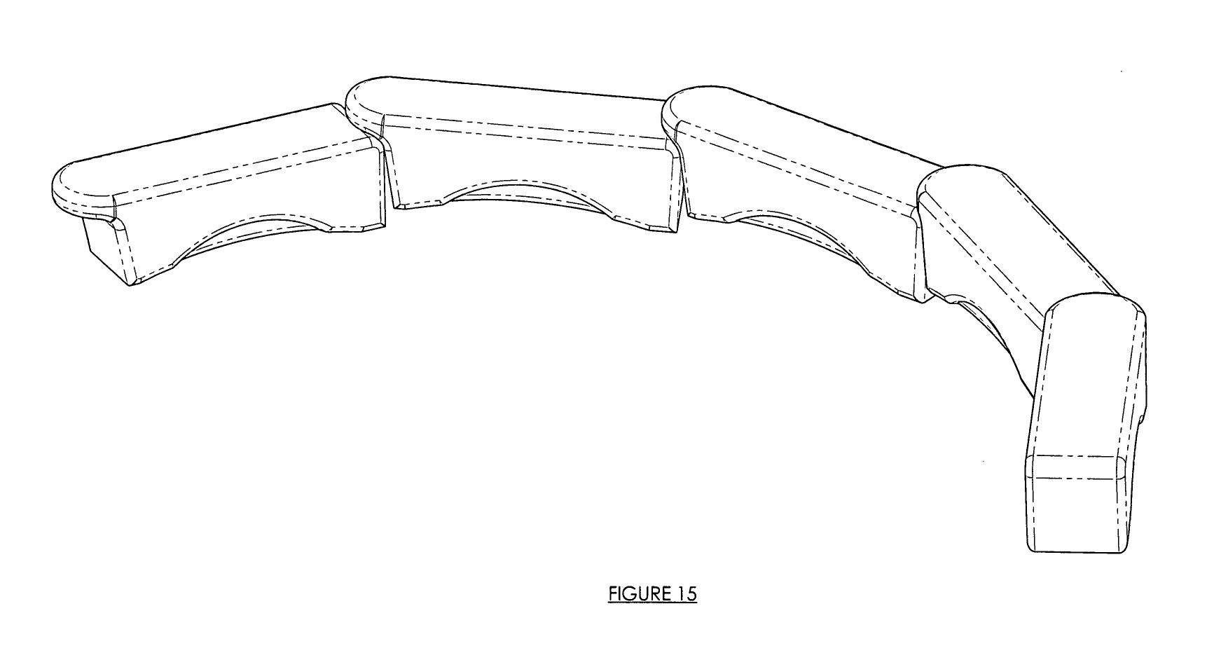

With reference to FIG. 13, in preparation for the smoking of food, a user may place the ledge 52 of one block 418 onto the shoulder 54 of a second block in order to provide a gravity assisted abutment therebetween. As shown in FIGS. 14 and 15 such blocks 418 may be arranged in a variety of configurations depending upon the dimension and geometry of the space in which they are to be used etc.

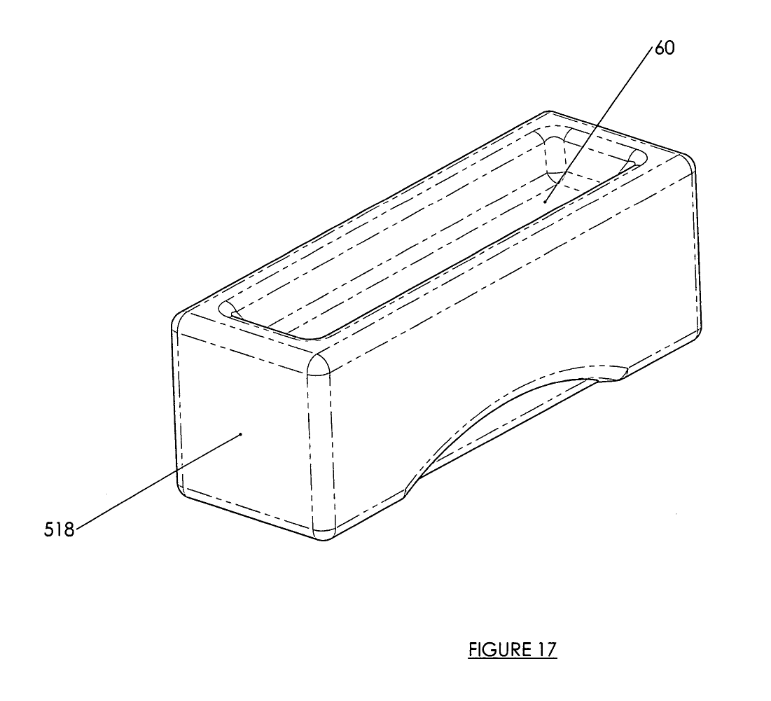

With reference to FIG. 17, a further embodiment according to the second aspect of the invention comprises a discrete block formation 518 having a complementary loose particulate or sprinkler channel 60 in its upper surface. This sprinkler channel 60 allows additional particulates of complementary material such as herbs, spices and other wood particulates to be sprinkled therein in order to alter the scent of smoke produced by the block 518 during smouldering.

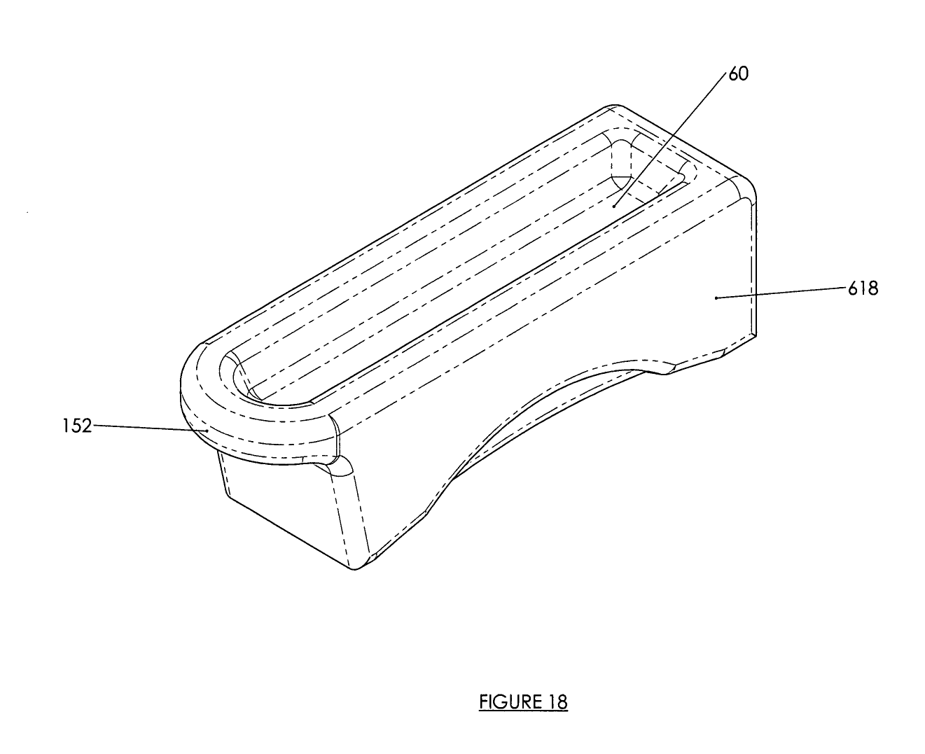

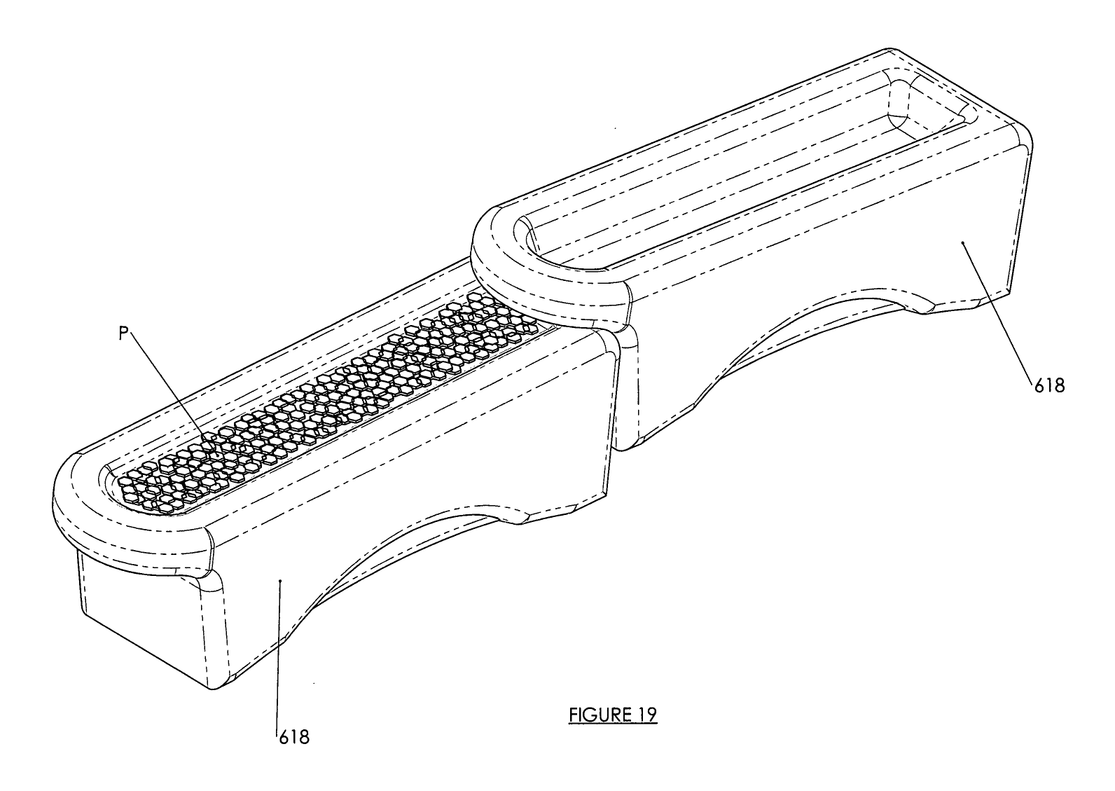

As shown in FIG. 18, a discrete block 618 which is similar to the discrete block 518 may be provided with a male protruding ledge 152 if desired. With reference to FIG. 19 this allows the block 618 to rest upon an end shoulder of a similar block 618 containing loose particulates P therein.

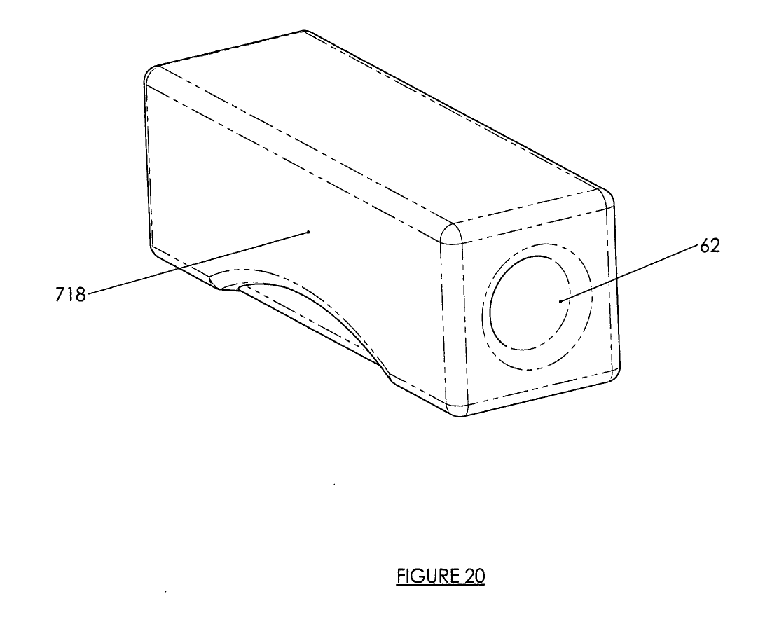

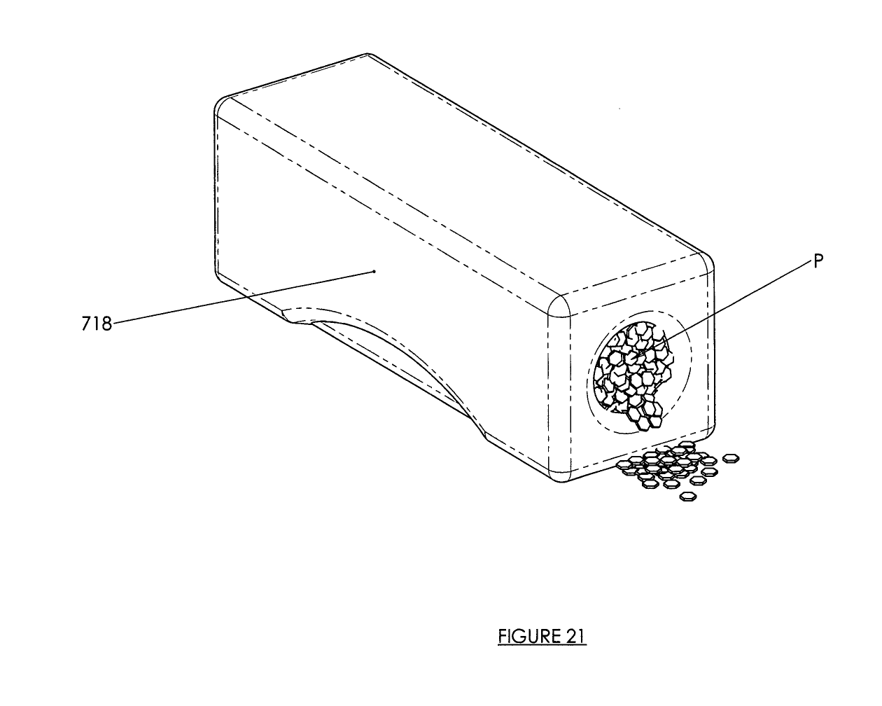

With reference to FIG. 20, a further embodiment according to the second aspect of the invention comprises a discrete block formation 718 having a loose particulate throughbore 62 along its centre. As shown in FIG. 21 the throughbore 62 allows loose particulates P to be inserted and retained therein for eventual scenting of smoke produced by smouldering of the discrete block 718.

In the above described arrangements, the discrete blocks can be used to both vary the total smoking time and also to facilitate the mixing of woods/herbaceous mixes etc. in order to achieve different flavour combinations. This could be used to provide e.g. three hours of oak smoke with an hour of cherry wood finish smoke.

In addition, blocks can be “branched-off”, and or run in parallel in addition to a chain of blocks in series in order to increase the flavour mixes and smoke density wherever desired.

Furthermore, the discrete blocks may also be provided with reinforcement wires or skewers in order to provide further strength and protection thereto as well as improving ash containment.

Although particular embodiments of the invention have been disclosed herein in detail, this has been done by way of example and for the purposes of illustration only. The aforementioned embodiments are not intended to be limiting with respect to the scope of the statements of invention.

It is contemplated by the inventors that various substitutions, alterations, and modifications may be made to the invention without departing from the spirit and scope of the invention as defined by the statements of invention. Examples of these include the following:—

In an alternative to the embodiment of the food smoking apparatus 210, rather than having a removable cover 44, a sealed unit can be provided where a tip of the food smoking cake projects through a small hole (or indeed the upper vent aperture for lighting when desired). In such an arrangement, the tip of the food smoking cake projecting through the vent aperture may be protected by a removable plug or cap.

The embodiments of the discrete blocks described do not require male protruding ledges but instead may simply abut end-to-end or on top of one another.

Furthermore, if desired the blocks can be arranged in a perpendicular T-shape or branch arrangement in order to produce greater quantities of smoke during particular time periods during smoking.

The type of natural wood base used in the mixture can be varied to provide a selection of different smoking aromas suited to the tastes of different users. For example, oak, beech, hickory, maple, cherry, apple, pear or alder wood powder/dust could be used. Furthermore, wood powder/dust derived from different types of wood can be mixed together to create interesting aromas suited to particular tastes/food smoking applications.

The aroma or smoke produced, can also be changed by adding other natural components to the mixture such as for example herbaceous tinctures and exotic mixes.

The food smoking cake could be formed into a ridged block of weakly joined members enabling the user to easily snap off a desired number of blocks in order to allow the user to select a desired quantity of smoke to be produced for a desired amount of time.

Different lengths of food smoking cake can be provided in order to alter the overall food smoking time and/or different diameters of food smoking cake can be provided in order to alter the quantity of smoke produced at any given time.

Although the above described invention is primarily concerned with cold-smoking of foods, the apparatus could also be used in the hot-smoking of foods if desired.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A food smoking cake comprising:
a discrete block configured to be placed into abutment with at least one substantially similar block such that when an end one of a series of abutting blocks is lit by a flame, adjacent abutting blocks will each smoulder sequentially.

2. A food smoking cake as claimed in claim 1 wherein the discrete block comprises a main body having a projecting ledge section at one end and a corresponding shoulder section at the opposed end configured such that the ledge of one discrete block can be rested upon a corresponding shoulder section of an adjacent block.

3. A food smoking cake as claimed in claim 1 or claim 2 wherein the discrete block comprises a main body having a male portion at one end and a female portion at the opposed end, the female portion substantially corresponding to the male portion, the male and female portions configured such that a plurality of the discrete blocks can be arranged end-to-end in series with the male portion of one block in contact with the female portion of the adjacent block, and wherein contact between the male and female portions facilitates passage of smoulder heat from one block to the next.

4. A food smoking cake as claimed in any one of claims 1 to 3 wherein the discrete block further comprises a curved or otherwise profiled underside configured to facilitate circulation of air underneath the blocks during smouldering thereof.

5. A food smoking cake as claimed in any one of claims 1 to 4 wherein the discrete block further comprises a loose particulate receiving chamber configured to receive a complementary loose particulate therein.

6. A food smoking cake as claimed in claim 5 wherein the complementary loose particulate receiving chamber comprises a groove or channel provided along at least a portion of an upper surface of the discrete block.

7. A food smoking cake as claimed in claim 5 or claim 6 wherein the complementary loose particulate receiving chamber comprises a throughbore provided along at least a portion of the discrete block.

8. A food smoking cake as claimed in any one of claims 1 to 7 wherein the material that forms the discrete block comprises:
a minor part combustible natural plant base particulate which smoulders when lit by a flame, and;
a major part combustible wood base particulate which produces smoke when smouldering.

9. A food smoking cake as claimed in claim 8 wherein the combustible natural plant base particulate comprises a powder or resin derived from tree bark.

10. A food smoking cake as claimed in claim 8 or claim 9 wherein the combustible natural plant base particulate comprises makko powder from the persea genus.

11. A food smoking cake as claimed in claim 10 wherein the combustible natural plant base particulate comprises makko powder from the machilus thunbergii tree.

12. A food smoking cake as claimed in claim 8 or claim 9 wherein the combustible natural plant base particulate comprises xiangnan pi from the phoebe genus.

13. A food smoking cake as claimed in any one of claims 8 to 12 wherein the natural plant base particulate comprises substantially between 1 to 20% of the material and the combustible wood base comprises substantially between 80 to 99% of the mixture.

14. A food smoking cake as claimed in any one of claims 8 to 12 wherein the natural plant base particulate comprises substantially 10% and the combustible wood base comprises substantially 90% of the material.

15. A food smoking cake as claimed in any one of claims 8 to 14 wherein the combustible wood base particulate comprises powdered wood particulates obtained from at least one of the group consisting of oak, beech, hickory, maple, cherry, apple, pear, or alder wood.

16. A food smoking cake as claimed in claim 15 wherein the combustible wood base particulate further comprises at least one of herbaceous matter, infusions, flavour enhancers or other aromatic tinctures.

17. A disposable food smoking apparatus configured to create smoke over a prolonged period of time in order to impart a smoked flavour on food, the food smoking apparatus comprising:
a base configured to rest on a surface;
a food smoking cake.

18. A food smoking cake as claimed in claim 17 wherein the body of the food smoking cake comprises a convoluted form configured such that if one end of the convoluted form is lit by flame the cake will smoulder progressively along the length of the body.

19. A food smoking cake as claimed in claim 18 wherein the convoluted form comprises an upwardly extending coiled helix configuration.

20. A disposable food smoking apparatus as claimed in any one of claims 17 to 19 wherein the base further comprises an upwardly projecting mounting member configured so that an upwardly extending helical coil of food smoking cake can be positioned there around.

21. A disposable food smoking apparatus as claimed in claim 20 further comprising a cover configured to enclose the mounting member and cake, the cover having at least one lower air breathing aperture, and at least one upper smoke exhaust aperture.

22. A disposable food smoking apparatus as claimed in claim 21 wherein the cover further comprises an air regulator located at or close to the lower air breathing aperture configured to control air flow through the lower air breathing aperture to control the rate of combustion and hence smoke levels produced by the food smoking cake when lit.

23. A disposable food smoking apparatus as claimed in claim 17 or claim 18 wherein the base is configured to form a container adapted to receive the food smoking cake therein, the container and cake mutually configured so that the cake can locate within the container as a unitary item.

24. A food smoking cake as claimed in claim 18 wherein the convoluted form comprises a flattened, convoluted configuration.

25. A disposable food smoking apparatus as claimed in claim 23 further comprising a lower aerating shelf locating in use within the base portion and configured to retain the food smoking cake and space the cake away from the floor of the container.

26. A disposable food smoking apparatus as claimed in claim 25 wherein the lower aerating shelf comprises a wire mesh grill.

27. A disposable food smoking apparatus as claimed in claim 25 or claim 26 further comprising an upper retaining shelf configured to locate on top of the food smoking cake to sandwich the food smoking cake between the upper retaining shelf and the lower aerating shelf

28. A disposable food smoking apparatus as claimed in claim 27 wherein the upper retaining shelf comprises a wire mesh grill.

29. A disposable food smoking apparatus as claimed in any one of claims 23 to 28 wherein the base further comprises a first access aperture configured to allow external access to a first end of the food smoking cake so that the cake can be lit by a flame.

30. A disposable food smoking apparatus as claimed in claim 29 wherein the base further comprises a second access aperture configured to allow external access to a second end of the food smoking cake so that the cake can be lit by a flame.

31. A disposable food smoking apparatus as claimed in claim 29 or claim 30 wherein the base further comprises at least one hinged flap of material configured to be movable between a position where the access aperture is open, and a position substantially closing the access aperture.

32. A disposable food smoking apparatus as claimed in claim 29 or claim 30 wherein the base plate further comprises at least one slider configured to be movable between a position where the access aperture is open, and a position substantially closing the access aperture.

33. A disposable food smoking apparatus as claimed in any one of claims 25 to 32 further comprising a drip tray having at least one aperture therethrough and configured to locate in use atop the upper retaining shelf.

34. A method of forming a food smoking cake comprising the steps of:
choosing a combustible wood base particulate of the type that produces smoke when smouldering; and
choosing a combustible natural plant base particulate of the type that smoulders when lit by a flame;
combining the wood base particulate and natural plant base particulate with a binding agent to form a substantially homogenous and malleable mixture with the wood base particulate as the major portion thereof;
forming the mixture into the required shape or shapes;
drying the formed mixture to remove the binding agent therefrom.

35. A method of forming a food smoking cake as claimed in claim 34 wherein in the step of combining the wood base particulate and natural plant base particulate with a binding agent, the binding agent is a liquid.

36. A method of forming a food smoking cake as claimed in claim 35 wherein in the step of combining the wood base particulate and natural plant base particulate with a binding agent, the binding agent is water.

37. A method of forming a food smoking cake as claimed in any one of claims 34 to 36 wherein in the step of forming the mixture into the required shape or shapes the forming operation can be performed by one or more of hand forming, press moulding or by extrusion from a tube.

38. A method of forming a food smoking cake as claimed in any one of claims 34 to 37 wherein in the step of choosing a combustible natural plant base particulate, the plant base particulate chosen comprises a powder or resin derived from tree bark.

39. A method of forming a food smoking cake as claimed in claim 38 wherein the plant base particulate chosen comprises makko powder from the persea genus.

40. A method of forming a food smoking cake as claimed in claim 38 wherein the plant base particulate chosen comprises makko powder from the machilus thunbergii tree.

41. A method of forming a food smoking cake as claimed in claim 38 wherein the plant base particulate chosen comprises xiangnan pi from the phoebe genus.

42. A method of forming a food smoking cake as claimed in any one of claims 34 to 41 wherein in the step of combining the wood base particulate and natural plant base particulate the mixture is formed so that natural plant base particulate comprises substantially between 1 to 20% of the material in the mixture.

43. A method of forming a food smoking cake as claimed in any one of claims 34 to 41 wherein in the step of combining the wood base particulate and natural plant base particulate the mixture is formed so that natural plant base particulate comprises substantially 10% of the material in the mixture.

44. A method of forming a food smoking cake as claimed in any one of claims 34 to 43 wherein in the step of choosing the combustible wood base particulate, the wood base particulate chosen comprises powdered wood particulates obtained from at least one of the group consisting of oak, beech, hickory, maple, cherry, apple, pear, or alder wood.

45. A method of forming a food smoking cake as claimed in claim 44 wherein the combustible wood base particulate further comprises at least one of herbaceous matter, infusions, flavour enhancers or other aromatic tinctures.
